(19) United States
(12) Patent Application Publication
(10) Pub. No.: US 2002/0107022 A1
(43) Pub. Date: Aug. 8, 2002

(54) Method of optimizing data transfer in a cellular mobile radio system

(75) Inventor: Vincent Muniere, Paris (FR)

Correspondence Address: SUGHRUE MION, PLLC, Suite 800, 2100 Pennsylvania Avenue, Washington, DC, 20037-3213, US

(73) Assignee: ALCATEL

(21) Appl. No.: 10/067,408

(22) Filed: Feb. 7, 2002

(30) Foreign Application Priority Data
Feb. 8, 2001 (FR) 01 01 707

(51) Int. Cl. H04Q 7/20

(52) U.S. Cl. 455/439

(57) ABSTRACT

A method of optimizing data transfer in a cellular mobile radio system which implements a procedure liable to disturb said transfer of data, wherein said transfer of data is continued during implementation of said procedure with a reduced size of the radio protocol data units transferred.

The present invention relates generally to cellular mobile radio systems.

The present invention relates more particularly to packet mode services such as general packet radio services (GPRS) for Global System for Mobile communications (GSM) mobile radio systems.

### BACKGROUND OF THE INVENTION

The architecture of GPRS systems, shown in FIG. 1, essentially comprises:

base transceiver stations (BTS) communicating with mobile stations (MS) and base station controllers (BSC), the combination of the BTS and the BSC constituting a base station subsystem (BSS), and

entities such as serving GPRS support node (SGSN) entities communicating with the BSS and with gateway GPRS support node (GGSN) entities themselves communicating with external networks (not shown).

In the multilayer architecture used in the above systems, the Um interface between the MS and the BSS comprises:

a first layer called the physical layer, and

a second layer called the data link layer and in turn divided into (in ascending order) a medium access control (MAC) layer and a radio link control (RLC) layer.

Similarly, the Gb interface between the BSS and the SGSN comprises:

a first layer called the physical layer, and

a second layer called the data link layer and in turn divided into (in ascending order) a frame relay or IP/UDP layer, a network service (NS) layer and a BSS GPRS protocol (BSSGP) layer.

In addition, in the MS and SGSN entities, the LLC layer sets up a second level logical link transparent to the BSS; in addition, a dedicated sub-network dependent convergence protocol (SNDCP) layer converts from a higher level (third layer or network layer) protocol to the GPRS second layer protocol.

In particular, the SNDCP layer segments packets known as network layer protocol data units (N-PDU) into data units known as SN-protocol data units (SN-PDU), as shown in FIG. 2.

LLC frames are then formed in the LLC layer from SN-PDU. In the LLC frames the SN-PDU are then called LLC-protocol data units (LLC-PDU).

The LLC-PDU are then segmented in the RLC/MAC layer to form blocks known as RLC data blocks, which are then converted to the format required for transmission over the Um interface in the physical layer.

The RLC and LLC layers use procedures for re-transmitting data (RLC data blocks or LLC-PDU) that has not been received correctly, using the automatic repeat request (ARQ) technique. The receiver signals the status (correct or incorrect) of the data units or blocks received to the sender by means of acknowledgment (ACK) or non-acknowledgment (NACK) messages.

In addition, higher level signaling protocols are also provided, in particular for radio resource management, also known as GPRS radio resource (GRR) management, mobility management, also known as GPRS mobility management (GMM), session management (SM), etc.

For a more detailed description of these systems see the corresponding standards published by the corresponding standards organizations.

In addition, these systems have a cellular architecture and handover techniques are provided for transferring circuit mode calls from cell to cell as and when required.

A cell change procedure is generally used for packet mode services, and a distinction is generally drawn between various cell change control modes, corresponding to decreasing levels of autonomy of the mobile station or increasing levels of control by the network, which amounts to the same thing. In the GPRS, for example, as specified in the standard 3GPP TS 04.60 V8.7.0 (2000-11) published by the 3^{rd} generation partnership project (3GPP):

In a first control mode (called the NC0 mode), the mobile station decides autonomously to effect a handover and itself selects the target cell to which the call is to be handed over, taking into account the results of measurements that, it carries out.

In a second control mode (called the NC1 mode), the mobile station decides autonomously to effect a handover and itself selects the target cell to which the call is to be handed over, taking into account the results of measurements that it carries out, and in addition it sends said measurement results to the network.

In a third control mode (called the NC2 mode), the network decides to effect handover and selects the target cell to which the call is to be handed over, taking into account measurement results transmitted to it by the mobile station.

Once the target cell to which the call in progress is to be handed over has been selected, using one of the above control modes, the problem of packet mode access to that target cell by the mobile station arises.

For this it is necessary for the mobile station to acquire information known as system information and broadcast on a common channel in the target cell; the common channel can be the packet broadcast control channel (PBCCH) or the broadcast control channel (BCCH), as is also specified in the aforementioned document. If the PBCCH is used, the system information is known as packet system information. The system information includes information indicating to the mobile station how to access the target cell in packet mode. In contrast to the handover procedure provided in circuit mode, the resources to be used in the target cell are not predetermined by the network. The system information includes a number of parameters for configuring the cell change procedure. Some system information is needed before the mobile station is authorized to access the target cell, and differs according to whether it is conveyed on the PBCCH or the BCCH.

The method of broadcasting the necessary system information on the PBCCH or BCCH is such that the time for the mobile station to acquire the information is not predetermined and can be extremely long. This can affect data transfer in the downlink direction. The SGSN continues to transfer LLC-PDU to the BSS, which attempts to deliver them to the mobile station in the form of RLC data blocks. However, as the mobile station is in the process of acquiring system information relating to the target cell, many RLC data blocks are lost, i.e. are not received by the mobile station. As specified in the standard previously cited, the mobile station is then authorized to suspend the operations in progress in the old cell for the time necessary to receive the required messages on the BCCH or the PBCCH of the target cell. Many retransmissions may then be necessary at the level of the RLC/MAC layer and/or the LLC layer, the essential drawbacks of which are that this delays the transfer of data (and therefore degrades the quality of service) and does not correspond to optimum use of the radio resources.

To limit these drawbacks, according to the standard 3GPP TS 08.18 V8.7.0 (2000-11) published by the 3GPP, if the BSS has instructed a mobile station to execute a cell change (in the NC2 control mode), the following steps are carried out:

the GMM layer supplies a service primitive “GMM-RADIO STATUS.req” to the BSSGP layer to request it to send a “RADIO-STATUS PDU” message to the SGSN,

the BSS transmits the message “RADIO-STATUS PDU” via the BSSGP layer to the SGSN to inform it that the network has instructed a cell change,

the BSSGP layer in the SGSN then supplies a service primitive “GMM-RADIO-STATUS.ind” to the GMM layer to tell it that the BSS has instructed a cell change,

the SGSN then suspends the transfer of LLC-PDU in the downlink direction (to the mobile station) by sending a service primitive “LLGMM-SUSPEND-REQ” to the LLC layer,

when a cell update message is received from the mobile station, indicating that the cell change has been effected successfully, the SGSN then sends a signaling message “FLUSH-LL PDU” to the entity controlling the old cell,

after deleting the LLC-PDU received by the entity controlling the old cell before transmitting the message “RADIO STATUS PDU”, and not yet acknowledged if the LLC is operating in acknowledged mode, or after transfer of the data units to the entity controlling the new cell, a message “FLUSH LL-ACK PDU” is sent to the SGSN, and

the GMM layer of the SGSN then sends a service primitive “LLGMM-RESUME-REQ” to the LLC layer so that the transfer of LLC-PDU in the downlink direction resumes.

However, that kind of solution has the essential disadvantage that, because of the cell change procedure, it suspends the transfer of data for an uncontrolled time period which is not predetermined and can be extremely lengthy. This can lead to the expiry of timers at the level of higher layers on top of the LLC layer, which also degrades the quality of service. This can also and unnecessarily trigger some retransmission at the level of the LLC layer, which also degrades the quality of service and represents non-optimum use of the radio resources.

### OBJECTS AND SUMMARY OF THE INVENTION

An object of the present invention is to avoid the drawbacks cited above as much as possible. The present invention can be applied to any procedure employed in said system and liable to disturb the transfer of data, the cell change procedure previously mentioned being merely one example of this kind of procedure.

The present invention therefore provides a method of optimizing data transfer in a cellular mobile radio system which implements a procedure liable to disturb said transfer of data, wherein said transfer of data is continued during implementation of said procedure with a reduced size of the radio protocol data units transferred.

According to another feature, said procedure is a cell change procedure.

According to another feature, said system is a GPRS system and said radio protocol data units are logical link control protocol data units (LLC-PDU) obtained in particular by segmenting higher level network layer protocol data units (N-PDU).

The present invention also provides a cellular mobile radio network entity for implementing the above method, the entity essentially including:

means for transferring radio protocol data units of reduced size during implementation of said procedure.

According to another feature, said entity includes, when said network is a GPRS network and said radio protocol data units are logical link control protocol data units (LLC-PDU) obtained by segmenting higher level network layer protocol data units (N-PDU):

means for segmenting said higher level protocol data units into radio protocol data units of reduced size during implementation of said procedure.

According to another feature, said entity is a serving GPRS support node (SGSN) entity.

The present invention also provides a mobile station for implementing the above method, the mobile station essentially including:

means for receiving radio protocol data units of reduced size during implementation of said procedure.

According to another feature, said mobile station further includes, when said network is a GPRS network and said radio protocol data units are logical link control protocol data units (LLC-PDU) obtained for example by segmenting higher level network layer protocol data units (N-PDU):

means for reassembling said higher level protocol data units into higher level radio protocol data units during implementation of said procedure.

### BRIEF DESCRIPTION OF THE DRAWINGS

Other objects and features of the present invention will become apparent on reading the following description of embodiments of the invention, which description is given with reference to the accompany drawings, in which:

FIG. 1 (described above) is a diagram outlining the general architecture of a GPRS cellular mobile radio system,

FIG. 2 (described above) is a diagram outlining the principle of forming the data units or blocks processed in this kind of system, and

FIG. 3 is a diagram showing one implementation of a method of the invention.

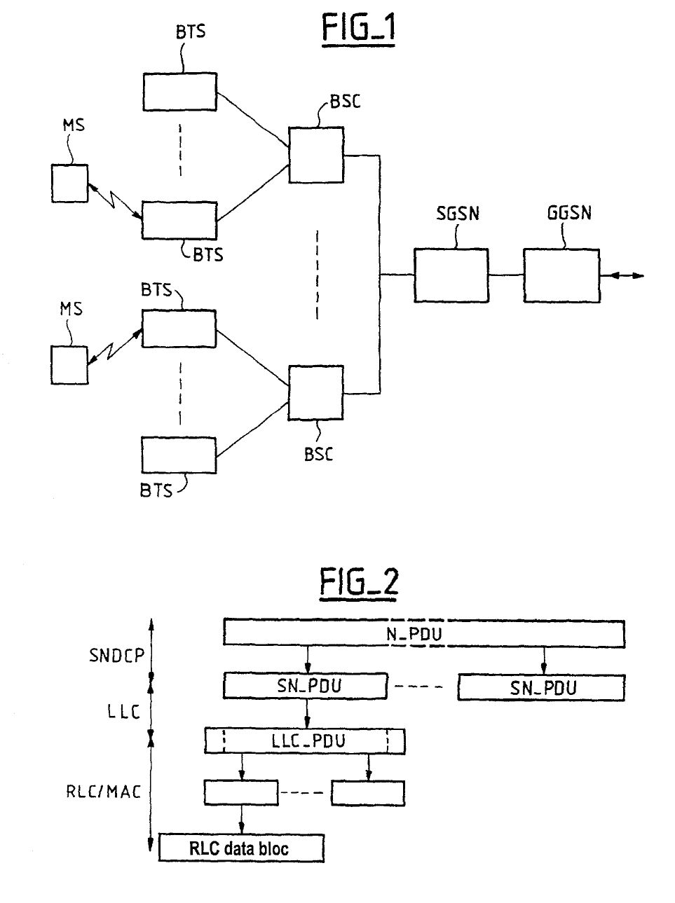

### MORE DETAILED DESCRIPTION

Thus the present invention provides a method of optimizing transfer of data in a cellular mobile radio system that uses a procedure likely to disturb the transfer of data.

In accordance with the invention, the transfer of data is continued when implementing this kind of procedure, but with a reduced size of the radio protocol data units transferred.

For example, the procedure referred to in the following description is a cell change procedure.

In addition, the present invention is described hereinafter more particularly and by way of example in the case of a GPRS system. The radio protocol data units are then LLC-PDU, obtained in particular by the SNDCP layer segmenting N-PDU, as previously described.

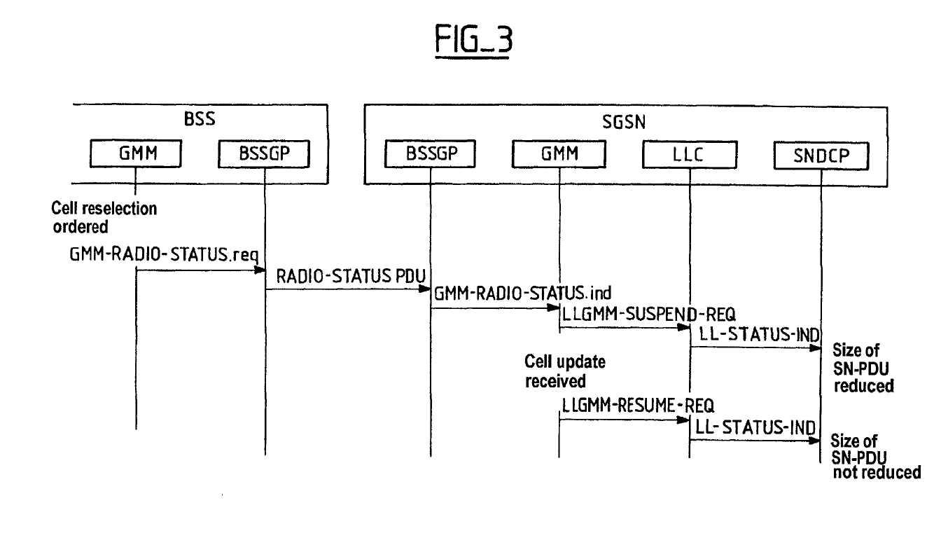

In this example, at the time of a cell change, the SGSN continues to transfer LLC-PDU, but these data units are then of reduced size. Because the LLC layer does not segment the SN-PDU into LLC-PDU, the SN-PDU must themselves be supplied with a reduced size to the LLC layer. For this it is necessary to inform the SNDCP layer of the cell change. For example, for a cell change instructed by the network (corresponding to the NC2 control mode previously mentioned), the steps shown in FIG. 3 can be used, implemented in the SGSN on receipt of a message “RADIO STATUS PDU” informing the SGSN that the network has instructed a cell change.

The FIG. 3 example is based on re-using some of the service primitives already used between the protocol layers of the BSS and the SGSN. This kind of re-use is obtained by specifying the new type of service (corresponding to use in accordance with the invention) in the characteristic parameters of said primitives. Such re-use is essentially aimed at obtaining the advantages of the method in accordance with the invention without substantially modifying the system.

In this example, the following primitives are re-used in this way:

“GMM-RADIO-STATUS.req”, as defined in the standard 3GPP TS 08.18 V8.7.0 (2000-11), supplied by the GPRS mobility management (GMM) layer to the BSSGP layer, so that the BSSGP layer can be requested to send a message “RADIO-STATUS PDU” to the SGSN,

“GMM-RADIO-STATUS.ind”, as defined in the standard 3GPP TS 08.18 V8.7.0 (2000-11), supplied by the BSSGP layer to the GMM layer, to inform the GMM layer that a message “RADIO-STATUS PDU” has been received from the BSS,

(Note that the above two primitives contain a message “RADIO-STATUS PDU” whose “radio cause” value is: “Cell change commanded”. The present invention does not necessitate any change to the use of these primitives).

“LLGMM-SUSPEND-REQ”, as defined in the standard 3GPP TS 24.007 V3.6.0 (2000-12), supplied by the GMM layer to the LLC layer, to request the LLC layer to suspend the current LLC transfer in the downlink direction; the present invention proposes to use this primitive to request the LLC layer to continue its transfer in the downlink direction, but with LLC-PDU of reduced size,

“LLGMM-RESUME-REQ”, as defined in the standard 3GPP TS 24.007 V3.6.0 (2000-12), supplied by the GMM layer to the LLC layer, to request the LLC layer to resume the current LLC transfer in the downlink direction, and

“LL-STATUS-IND”, as defined in the standard 3GPP TS 24.007 V3.6.0 (2000-12), supplied by the LLC layer to the SNDCP layer, to inform the SNDCP layer of faults or errors in lower layers; the present invention proposes to use this primitive to request the SNDCP layer to segment the N-PDU into data units of reduced size or to resume a normal mode of operation.

Accordingly, in the example shown in FIG. 3:

if the BSS decides on a cell change, the GMM layer supplies a service primitive “GMM-RADIOSTATUS.req” to the BSSGP layer, which then sends the message “RADIO-STATUS PDU” to the SGSN,

on receiving the message “RADIO-STATUS PDU” informing the SGSN of a cell change instructed by the BSS, the BSSGP layer supplies to the GMM layer a service primitive “GMM RADIO-STATUS” including characteristic parameters to inform the GMM entity that the network has instructed a cell change,

the GMM entity then supplies to the LLC layer a service primitive “LLGMM-SUSPEND-REQ” including characteristic parameters to inform the LLC layer that the LLC-PDU must then be of reduced size, and

the LLC layer then supplies to the SNDCP layer a service primitive “LL-STATUS-IND” including characteristic parameters to inform the SNDCP layer that the SN-PDU must then be of reduced size.

The size required for the LLC-PDU can be specified in the characteristic parameters of said primitives, or a default value can be assumed.

Then, when the cell change has been effected successfully, the reception by the SGSN of a cell update message instigates the sending of the primitives “LLGMM-RESUME-REQ” and “LL-STATUS” to the corresponding layers, in order to stop the reduction of the size of the LLC-PDU.

If the cell change cannot be effected, the mobile station sends a RLC/MAC signaling message “Packet Cell Change Failure” to the BSS entity controlling the old cell. The present invention proposes that this then instigates sending by the BSSGP layer of the BSS of a primitive “GMM-RADIO STATUS” to inform the GMM entity of cell change failure. A new cause can be introduced for this purpose. The LLC and SNDCP layers are then informed of the cell change failure by means of the primitives “LLGMM-RESUME-REQ” and “LL-STATUS”, in order to stop the reduction of the size of the LLC-PDU.

It will be noted that the foregoing description corresponds to a particular system, in this instance the GPRS system, and to a particular cell change mode (in this instance the NC2 mode), but that the invention is not limited to this system and/or to this cell change mode. In addition, in these examples, the invention is not limited to the particular procedure shown by way of example in FIG. 3. Neither is the invention limited to a cell change, but applies to any procedure that can interfere with the transfer of data, in particular because the procedure would entail very long retransmissions if said data units were to continue to be segmented with the maximum size.

The present invention also provides, in addition to the above method, a cellular mobile radio network entity and a mobile station including means for implementing the method.

Thus a cellular mobile radio network entity for implementing a method according to the invention essentially includes:

means for transferring radio protocol data units of reduced size during implementation in the system of any procedure liable to disturb the transfer of data.

According to another feature, said entity further includes:

means for segmenting higher level protocol data units into radio protocol data units of reduced size during implementation of said procedure.

Similarly, a mobile station for implementing a method according to the invention essentially includes:

means for receiving radio protocol data units of reduced size during implementation in the system of any procedure liable to disturb the transfer of data.

According to another feature, said mobile station further includes:

means for reassembling said higher level protocol data units into higher level radio protocol data units during implementation of said procedure.

The specific implementation of such means represents no particular problem to the person skilled in the art, and so such means do not need to be described in more detail here than by specifying their function, as above.

1. A method of optimizing data transfer in a cellular mobile radio system which implements a procedure liable to disturb said transfer of data, wherein said transfer of data is continued during implementation of said procedure with a reduced size of the radio protocol data units transferred.

2. A method according to claim 1, wherein said procedure is a cell change procedure.

3. A method according to claim 1, wherein said system is a GPRS system and said radio protocol data units are logical link control protocol data units obtained in particular by segmenting higher level network layer protocol data units.

4. A cellular mobile radio network entity for implementing a method according to claim 1, the entity including:
means for transferring radio protocol data units of reduced size during implementation of said procedure.

5. An entity according to claim 4, including, when said network is a GPRS network and said radio protocol data units are logical link control protocol data units obtained by segmenting higher level network layer protocol data units:
means for segmenting said higher level protocol data units into radio protocol data units of reduced size during implementation of said procedure.

6. An entity according to claim 5, the entity being a serving GPRS support node entity.

7. A mobile station for implementing a method according to claim 1, the mobile station including:
means for receiving radio protocol data units of reduced size during implementation of said procedure.

8. A mobile station according to claim 7, further including, when said network is a GPRS network and said radio protocol data units are logical link control protocol data units obtained for example by segmenting higher level network layer protocol data units:
means for reassembling said higher level protocol data units into higher level radio protocol data units during implementation of said procedure.
